(19) United States
(12) Patent Application Publication
(10) Pub. No.: US 2025/0224356 A1
(43) Pub. Date: Jul. 10, 2025

(54) SAMPLE CONTAINER AND THERMAL ANALYZER

(71) Applicant: HITACHI HIGH-TECH SCIENCE CORPORATION, Tokyo (JP)

(72) Inventors: Ryokuhei YAMAZAKI, Tokyo (JP); Hirohito FUJIWARA, Tokyo (JP); Shuta NAKAGAWA, Tokyo (JP)

(21) Appl. No.: 18/983,157

(22) Filed: Dec. 16, 2024

(30) Foreign Application Priority Data
Jan. 9, 2024 (JP) 2024-001126

(51) Int. Cl. G01N 25/48; G01N 5/04

(52) U.S. Cl. CPC G01N 25/486; G01N 5/04

(57) ABSTRACT

A sample container and a thermal analyzer that enable stable observation of measurement samples in thermal analysis are proposed. The sample container is a sample container used with a thermal analyzer for measurement of thermal behavior according to a temperature variation from heating or cooling of a measurement sample and observes the measurement sample. The sample container includes a body in a cylindrical shape having a bottom and an open top, a transparent or translucent pressure plate accommodated in the body to press the measurement sample placed on a bottom surface of the body from a top, and a lid accommodated in the body, placed on top of the pressure plate, and having a hole for observing the measurement sample.

### CROSS REFERENCE TO RELATED APPLICATION

The present application claims priority to Japanese Patent Applications No. JP2024-001126, filed Jan. 9, 2024, the entire contents of which are incorporated herein for all purposes by this reference.

### BACKGROUND

### 1. Technical Field

The present disclosure relates to a sample container used with a thermal analyzer that heats a (measurement) sample and measures physical variations including measurement of thermal weight and heat quantity of the measurement sample accompanying a temperature variation, and a thermal analyzer using the sample container.

### 2. Description of the Related Art

In the related art, a technique called thermal analysis that heats a sample and measures physical variations of the sample accompanying a temperature variation has been used as a technique of evaluating the temperature characteristic of a sample. Thermal analysis is defined in “General rules for thermal analysis” in JIS K 0129:2005 and techniques of measuring physical properties of a measurement target (sample) when the temperature of the sample is controlled by a program are all called thermal analysis. As general thermal analysis, there are five kinds of methods, (1) differential thermal analysis (TDA) that detects a temperature (temperature difference), (2) differential scanning calorimetry (DSC) that measures a heat flow difference, (3) thermogravimetry (TG) that detects mass (weight variation), (4) thermomechanical analysis (TMA) that detects dynamic characteristics, and (5) dynamic mechanical analysis (DMA).

Further, there is also a thermogravimeter-differential thermal analyzer (TG/DTA or TG/DSC) that simultaneously measures thermal weight and differential heat (e.g., see Patent Document 1).

Further, recently, there is a demand for observing the state of samples in thermal analysis, so a thermal analyzer having an opening at a furnace for heating a sample so that it is possible to observe a sample through the opening has been known (e.g., see Patent Documents 1 and 2). Cylindrical sample containers having a bottom and a top that is open, as described in Patent Document 2, are used for such observation.

However, thermal deformation such as contraction and bending may be generated in heating in film-type samples such as polymeric film or paper, but there is an issue that open-type sample containers of the related art cannot reduce this thermal deformation and samples cannot be observed through closed-type sample containers.

Further, the thermal analyzers enabling observation of samples in the related art have a problem that when thermal deformation is generated in heating or cooling, reflection and an angle variation is generated by reflective light due to an inclination variation of the sample surface, so it is difficult to observe the color or the structure of samples or the analysis region of samples is changed due to movement of samples that are being observed.

Accordingly, a technique of suppressing deformation, etc. of a sample by placing a transparent or translucent pressure plate on the top of a sample and inserting the sample between the bottom of a sample container and the pressing plate has been reported (Patent Document 3).

### RELATED ART DOCUMENTS

### Patent Documents

[Patent Document 1] Japanese Patent Laid-Open Publication No. Hei. 8-327573

[Patent Document 2] Japanese Patent Laid-Open Publication No. JP2015-108540

[Patent Document 3] Japanese Patent Laid-Open Publication No. JP2021-156862

### SUMMARY

However, the pressure plate described in Patent Document 3 strongly presses a sample to the bottom of the sample container due to its self-weight, so samples may be unnecessarily pressed or it may be difficult to uniformly press the entire surface of samples.

Further, when there is excessive thermal deformation of a sample, the pressure plate is folded or the sample is contracted by the deformation force of the sample, so it may be difficult to observe samples.

Accordingly, the present disclosure has been made in an effort to solve the problems described above and an objective of the present disclosure is to provide a sample container and a thermal analyzer that enable stable observation of a measurement sample in thermal analysis.

In order to achieve the objectives, a sample container for a thermal analyzer is a sample container used with a thermal analyzer for measurement of thermal behavior according to a temperature variation from heating or cooling of a measurement sample and observation of the measurement sample. The sample container includes a body in a cylindrical shape having a bottom and a top that is open, a transparent or translucent pressure plate accommodated in the body to press down on the measurement sample placed on the bottom surface of the body, and a lid accommodated in the body, placed on top of the pressure plate, and having a hole for observing the measurement sample.

According to the sample container for a thermal analyzer, since the lid is placed on a measurement sample in addition to the pressure plate, the measurement sample is sufficiently pressed, the entire surface of the measurement sample can be uniformly pressed, and it is possible to suppress deformation of the measurement sample or the pressure plate and stably observe the measurement sample in thermal analysis.

The sample container for a thermal analyzer of the present disclosure may further include a pressing means configured to press the lid toward the pressure plate.

According to the sample container for a thermal analyzer, since the lid is pressed by the pressing means, the pressure plate presses a measurement sample through the lid, so the measurement sample is more sufficiently pressed, it is possible to uniformly press the entire surface of the measurement sample, and it is possible to further suppress deformation of the measurement sample and the pressure plate.

In the sample container for a thermal analyzer of the present disclosure, the lid may form a flange vertically rising upward from an outer circumferential edge of the lid, the pressing means may be an edge of opening of the body and the flange, and at least portions of the edge of opening and the flange may be folded downward together.

According to the sample container for a thermal analyzer, since the edge of opening and the flange are folded, the lid can be easily pressed.

In the sample container for a thermal analyzer of the present disclosure, the sample container may have the measurement sample between the bottom surface of the body and the pressure plate, and the pressing means may be made of a bent portion from folding at least portions of the edge of opening of the body and the flange downward together.

According to the sample container for a thermal analyzer, the lid can be easily pressed due to the bent portion formed by folding the edge of opening and the flange.

In the sample container for a thermal analyzer of the present disclosure, 0.4≤C2/C1≤0.9 may be satisfied where a circle equivalent diameter of the lid is C1 and a circle equivalent diameter of the hole is C2.

In the sample container for a thermal analyzer of the present disclosure, thickness of the lid may be greater than or equal to thickness of a side wall of the body.

A thermal analyzer of the present disclosure includes the sample container for a thermal analyzer, a furnace surrounding the sample container and having an opening for observation, and an imaging means enabling observation of the measurement sample through the opening for observation, wherein the thermal analyzer measures thermal behavior of the measurement sample according to a temperature variation of the measurement sample in the furnace.

The thermal analyzer of the present disclosure may be a differential thermal analyzer, a differential scanning calorimeter, or a thermogravimetric apparatus.

The thermal analyzer may further include an image processing means configured to generate predetermined color information from image data of the measurement sample obtained through the imaging means, and the color information and the thermal behavior are displayed superimposed with respect to temperature.

According to the present disclosure, it is possible to achieve a sample container and a thermal analyzer that enable stable observation of measurement samples in thermal analysis.

### BRIEF DESCRIPTION OF THE DRAWINGS

FIG. 1 is a cross-sectional view showing the configuration of a thermal analyzer according to an embodiment of the present disclosure;

FIG. 2 is a perspective view showing the configuration of a sample container according to a first embodiment of the present disclosure;

FIG. 3 is an axial cross-sectional view of the sample container according to the first embodiment;

FIG. 4 is a view showing a bent portion of the sample container;

FIGS. 5A to 5D are views showing a process of folding the sample container;

FIG. 6 is an axial cross-sectional view of a sample container according to a second embodiment of the present disclosure;

FIG. 7 is a cross-sectional view in an assembled state of the sample container according to the second embodiment;

FIG. 8 is an axial cross-sectional view of a sample container according to a third embodiment of the present disclosure;

FIGS. 9A and 9B are views showing contraction of a lid according to a third embodiment seen from above; and

FIG. 10 is a flowchart illustrating the operation of a thermal analyzer using a sample container of the present disclosure.

### DETAILED DESCRIPTION

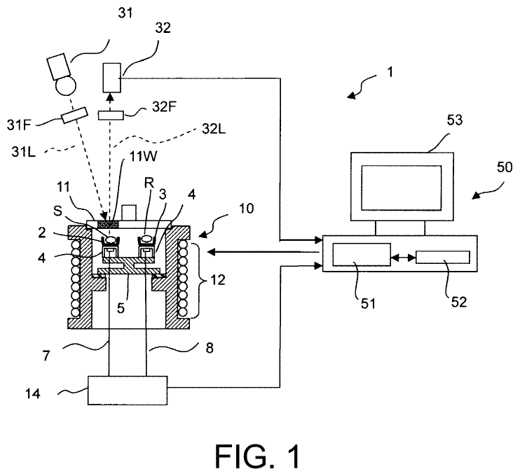

Hereinafter, embodiments of the present disclosure are described with reference to drawings. FIG. 1 is a cross-sectional view showing the configuration of a thermal analyzer according to an embodiment of the present disclosure.

A thermal analyzer 1 is a differential scanning calorimeter (DSC) and has the same configuration as differential scanning calorimeters of the related art except that a window 11W through which it is possible to observe the inside of a lid 11 of a furnace 10 is provided, so the summary is described.

The thermal analyzer 1 includes: a measurement sample container 2 that accommodates a measurement sample S; a reference substance container 3 that accommodates a reference substance R; a furnace 10; thermistors 4 that are connected between the measurement sample container 2, the reference substance container 3, and the furnace 10 and form heat flow paths therebetween; a measurement sample-side thermocouple 7; a reference substance-side thermocouple 8; a light source 31 that is a lighting unit for emitting visible light to at least the measurement sample S such as an LED; a CCD camera 32 that is an imaging means for photographing at least the measurement sample S; and a personal computer 50.

A heater 12 like wound wires is wound around the outer side of the furnace 10 and heats the furnace 10. The outer side of the heater 12 is covered with a cover (not shown).

The CCD camera 32, for example, is an area scan type, but may be a line scan type and other solid-state image sensing devices such as a CMOS camera may be used.

The personal computer 50 includes a Central Processing Unit (CPU) 51, a storage unit 52 such as a hard disk, a display 53 such as a liquid crystal monitor, a keyboard or a mouse (not shown), etc.

The furnace 10 is in a cylindrical shape and has an H-shaped axial cross-section. A substantially double disc-type thermal plate 5 is placed on a ring-shaped protrusion protruding inward in the diameter direction from the axial center.

The measurement sample container 2 and the reference substance container 3 are placed on the top of the thermal plate 5 with two thermistors 4 therebetween, respectively, and the measurement sample container 2 and the reference substance container 3 are accommodated in an internal space surrounded by the furnace 10.

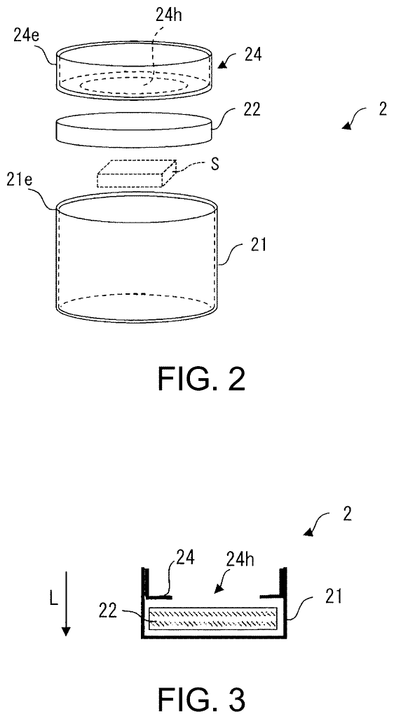

A measurement sample S is accommodated in the measurement sample container 2 and a pressure plate 22 and a lid 24 (FIG. 2) are placed on the top of the measurement sample S. The pressure plate 22 is made of a material that is transparent or translucent and transmits visible light with predetermined light transmittance. As the transparent (translucent) material, silica glass, sapphire glass, yttrium-aluminum-garnet (YAG) ceramic, Tempax, Neoceram (registered trademark), Vycor (registered trademark), and Pyrex (registered trademark) may be appropriately used.

Meanwhile, a pressure plate the same as that of the measurement sample container may also be placed on the reference substance R in the reference substance container 3 retaining the reference substance R so that the measurement sample S and the reference substance R are surely heated under the same condition in the furnace 10. Further, a pressure plate may not be placed on the reference substance R.

The measurement sample-side thermocouple 7 and the reference substance-side thermocouple 8 pass through the thermistors 4 and the thermal plate 5 and first ends thereof are connected to the bottoms of the measurement sample container 2 and the reference substance container 3, respectively, by soldering. Meanwhile, second ends of the measurement sample-side thermocouple 7 and the reference substance-side thermocouple 8 are drawn downward out of the furnace 10 and are connected to an amplifier 14 constituting a signal processing circuit.

Accordingly, the measurement sample-side thermocouple 7 and the reference substance-side thermocouple 8 form so-called differential thermocouples and make it possible to detect a temperature difference of the measurement sample S and the reference substance R. This temperature difference is recorded as a heat flow difference signal. Meanwhile, the temperature of a measurement sample is recorded from the measurement sample-side thermocouple 7.

The temperature of the furnace 10 is input to the CPU 51 through various control circuits and the CPU 51 controls application of electricity to the heater 12, whereby the furnace 10 is controlled to be heated or cooled at a predetermined rate.

The lid 11 is detachably placed over the opening at the upper end of the furnace 10, thereby isolating the inside of the furnace 10 from the external air.

A window 11W made of silica glass is disposed at the portion of the lid 11 that overlaps the measurement sample container 2 in the axial direction of the furnace 10 and the CCD camera 32 is disposed over the window 11W.

A light source 31 for lighting the measurement sample S in the furnace 10 through the window 11W is disposed above the window 11W on a line different from the axial line of the CCD camera 32.

Incident light (visible light) 31L is emitted to the measurement sample S from the light source 31 and the CCD camera 32 obtains luminance or intensity of reflective light 32L from the measurement sample S.

Filters 31F and 32F are disposed between the window 11W and the light source 31 and between the window 11W and the CCD camera 32, respectively, so only light with a specific component is emitted to the window 11W and only reflective light with a specific component is sent to the CCD camera 32. However, the filters 31F and 32F are not essential. In a coaxial episcopic illumination (half mirror type), the optical axis of the light source 31 of emitted light and the optical axis of the camera 32 are aligned.

Next, the sample container according to an embodiment of the present disclosure is described by exemplifying the measurement sample container 2. FIG. 2 is a perspective view showing the configuration of the measurement sample container 2 and FIG. 3 is a cross-sectional view of the measurement sample container 2 cut in the axial direction L.

The measurement sample container 2 includes a body 21 in a cylindrical shape having a bottom and a top that is open, a pressure plate 22, and a lid 24, in which the pressure plate 22 and the lid 24 are formed substantially in disc shapes having a diameter the same as or smaller than the inner diameter of the body 21.

The pressure plate 22 is transparent or translucent, as described above, and presses a measurement sample S placed on the bottom surface of the body 21 from the top.

The body 21 and the lid 24, for example, are made of aluminum (alloy).

The lid 24 is placed on the top of the pressure plate 22 and has one hole 24h for observing a measurement sample at the center.

The outer circumferential edge 24e of the lid 24 vertically protrudes upward, thereby forming a flange.

The number of the hole 24h is not limited and the position of the hole 24h is also not limited to the center.

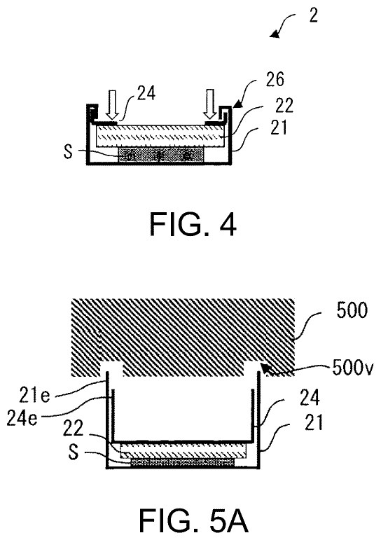

As shown in FIG. 4, at least portions of an edge of opening 21e of the body 21 and the outer circumferential edge (flange) 24e of the lid 24 are both folded downward (throughout the circumference in this embodiment) with a measurement sample S disposed between the bottom surface of the body 21 and the pressure plate 22, whereby a bent portion 26 is formed.

Since the bent portion 26 is formed, the lid 24 is pressed downward (toward the pressure plate 22), so the bent portion 26 corresponds to the ‘pressing means’ in claims.

The edge of opening 21e of the body 21 (the side wall in this embodiment) and the circumferential edge (flange) 24e of the lid 24 need to be substantially parallel and the lid 24 needs to have a flange so that folding is possible.

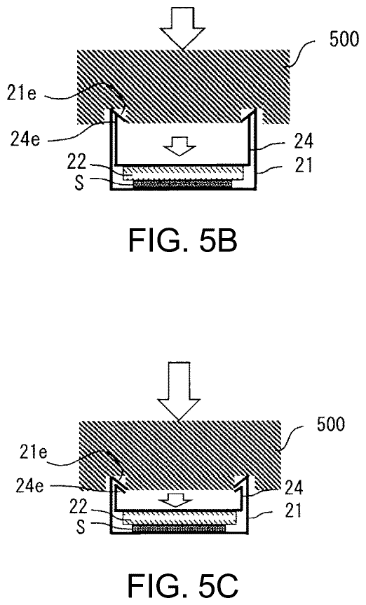

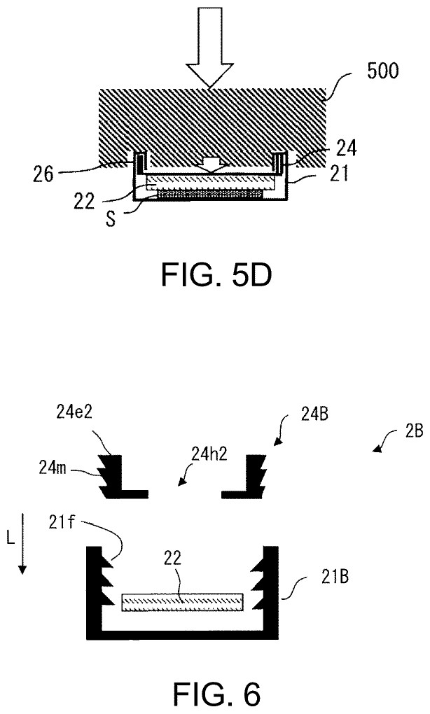

FIGS. 5A to 5D show a process of folding the measurement container 2.

First, a measurement sample S, the pressure plate 22, and the lid 24 are put into the body 21 in this order (FIG. 5A).

A grooved portion 500v of a bending jig 500 is pressed against the edge of opening 21e and the outer circumferential edge (flange) 24e from above the lid 24 (FIG. 5B). The edge of opening 21e protrudes upward (toward the bending jig 500) further than the outer circumferential edge (flange) 24e and is folded downward by the grooved portion 500v. In addition, by pressing the grooved portion 500v, the lid 24 is pressed downward.

The grooved portion 500v is a ring-shaped concave portion that can accommodate the edge of opening 21e.

The grooved portion 500v of the bending jig 500 is pressed against the edge of opening 21e and the outer circumferential edge (flange) 24e (FIG. 5C). Accordingly, the outer circumferential edge (flange) 24e is also folded downward.

The grooved portion 500v of the bending jig 500 is pressed deeper against the edge of opening 21e and the outer circumferential edge (flange) 24e (FIG. 5D). Accordingly, the edge of opening 21e covers the outer circumferential edge (flange) 24e, and the edge of opening 21e and the outer circumferential edge (flange) 24e of the lid 24 are folded together, whereby the bent portion 26 is formed.

As described above, since the lid 24 is placed on a measurement sample S in addition to the pressure plate 22, the measurement sample S is sufficiently pressed, the entire surface of the measurement sample S can be uniformly pressed, and it is possible to suppress deformation of the measurement sample S or the pressure plate 22 and stably observe the measurement sample in thermal analysis.

When the lid 24 is pressed by a pressing means, the pressure plate 22 presses the measurement sample S through the lid 24, so the measurement sample S is more sufficiently pressed, it is possible uniformly to press the entire surface of the measurement sample S, and it is possible to further suppress deformation of the measurement sample S or the pressure plate 22.

As long as the opening end 21e and the circumferential edge (flange) 24e are bent portions, they may be seams that are used for manufacturing cans, etc.

It is preferable to fold the entire of the opening end 21e and the circumferential edge (flange) 24e, but only a portion (e.g., four portions with regular intervals in the circumferential direction) of the circumferential edge may be folded as long as the measurement sample S is sufficiently pressed.

Assuming that a circle equivalent diameter of the lid 24 is C1 and a circle equivalent diameter of the hole 24h is C2, 0.4≤C2/C1≤0.9 may be preferable.

When (C2/C1) is less than 0.4, the hole 24h becomes small, so it may be difficult to observe a measurement sample S inside the lid 24.

When (C2/C1) exceeds 0.9, the hole 24h becomes excessively large and the width of the circumferential edge 24e of the lid 24 decreases, so the strength decreases and a measurement sample S may be insufficiently pressed due to folding of the lid 24 in a pressing state.

The thickness of the lid 24 may be greater than or equal to thickness of the side wall of the body 21.

When the thickness of the lid 24 is smaller than the thickness of the side wall of the body 21, the strength of the lid 24 decreases and a measurement sample S may be insufficiently pressed due to folding of the lid 24 in a pressing state.

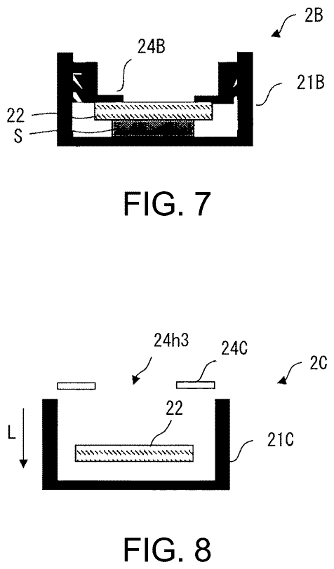

Next, a sample container 2B according to a second embodiment of the present disclosure is described with reference to FIG. 6 and FIG. 7. FIG. 6 is a cross-sectional view of the sample container 2B according to the second embodiment of the present disclosure cut in an axial direction L and FIG. 7 is a cross-sectional view in an assembled state of the sample container 2B.

The measurement sample container 2B includes a body 21B in a cylindrical shape having a bottom and a top that is open, a pressure plate 22, and a lid 24B, in which the pressure plate 22 and the lid 24B are formed substantially in disc shapes having a diameter the same as or smaller than the inner diameter of the body 21B.

The pressure plate 22 is the same as that in the case of the sample container 2 according to the first embodiment of the present disclosure, so it is not described.

Female threads 21f are formed on the inner surface of the side wall of the body 21B. The lid 24B is placed on the top of the pressure plate 22 and has one hole 24h2 for observing a measurement sample at the center.

An outer circumferential edge 24e2 of the lid 24B forms a side wall by vertically protruding upward and male threads 24m for thread-fastening with the female threads 24f are formed on the outer surface of the side wall.

As shown in FIG. 7, the male threads 24m of the lid 24B are thread-fastened to the female threads 21f of the body 21B with a measurement sample S disposed between the bottom surface of the body 21B and the pressure plate 22, whereby the lid 24B is pressed downward (toward the pressure plate 22). Accordingly, the female threads 21f and the male threads 24m correspond to the ‘pressing means’ in claims.

In the second embodiment as well, since the lid 24B and the pressure plate 22 press a measurement sample S, the measurement sample S is sufficiently pressed, the entire surface of the measurement sample S can be uniformly pressed, and it is possible to suppress deformation of the measurement sample S or the pressure plate 22 and stably observe the measurement sample in thermal analysis.

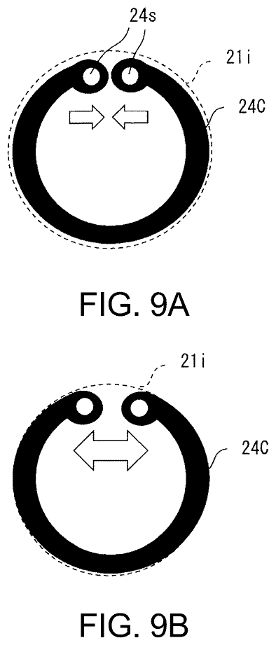

Next, a sample container 2C according to a third embodiment of the present disclosure is described with reference to FIG. 8 and FIG. 9A and 9B. FIG. 8 is a cross-sectional view of the sample container 2C according to the third embodiment of the present disclosure cut in an axial direction L and FIGS. 9A and 9B are views showing contraction of a lid 24C seen from above.

The measurement sample container 2C includes a body 21C in a cylindrical shape having a bottom and a top that is open, a pressure plate 22, and a lid 24C, in which the pressure plate 22 is formed substantially in a disc shape having a diameter the same as or smaller than the inner diameter of the body 21C.

The pressure plate 22 is the same as that in the case of the sample container 2 according to the first embodiment of the present disclosure, so it is not described.

The lid 24C has a ring shape, is placed on the top of the pressure plate 22, and has one hole 24h3 for observing a measurement sample at the center.

As shown in FIGS. 9A and 9B, the lid 24C is a C-shaped snap ring and the outer diameter of the lid 24C is larger than the inner diameter 21i of the body 21C in an open state.

The ends of tweezers, etc. are inserted into hold holes 24s at both ends of the lid 24C, the gap between the hold holes 24s is narrowed, and the lid 24C is pressed into the body 21C with a measurement sample S disposed between the bottom surface of the body 21C and the pressure plate 22 (FIG. 9A).

Thereafter, the lid 24C is released from contraction by removing the tweezers, the diameter of the lid 24C increases in the body 21C, whereby the lid 24C is fixed in the body 21C and is pressed downward (toward the pressure plate 22) (FIG. 9B). Accordingly, the circumferential edge of the lid 24C correspond to the ‘pressing means’ in claims.

In the third embodiment as well, since the lid 24C and the pressure plate 22 press a measurement sample S, the measurement sample S is sufficiently pressed, the entire surface of the measurement sample S can be uniformly pressed, and it is possible to suppress deformation of the measurement sample S and the pressure plate 22 and stably observe the measurement sample in thermal analysis.

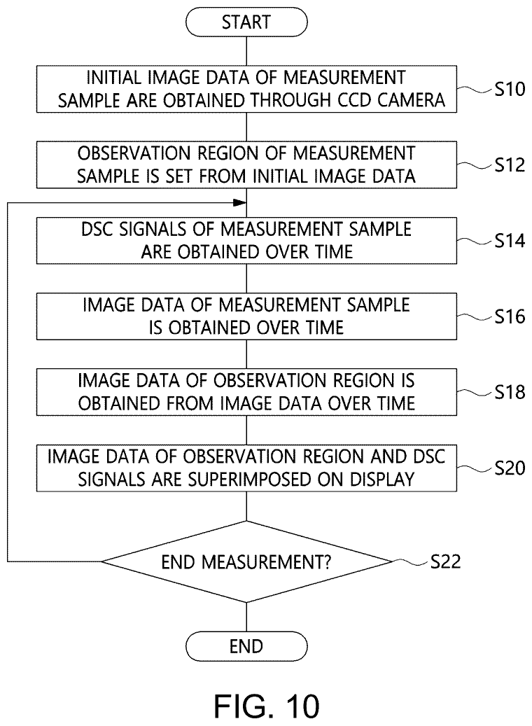

Next, the operation of a sample container and a thermal analyzer using the sample container is described with reference to the flowchart of FIG. 10.

First, visible light is emitted to a measurement sample S by the light source 31 and initial image data of the measurement sample S is obtained at the CPU 51 of the personal computer 50 using the CCD camera 32 (step S10).

Next, the image data is displayed on the display 53 of the personal computer 50 and a user sets the location information of an analysis region in the image of the measurement sample S on the display 53 using a mouse, a keyboard (not shown), or the like (step S12).

The location information may be one point or may be a region having an area following an outer edge. When one point is determined, a circle, etc. having a predetermined radius or a predetermined area around the point may be considered as a virtual region.

Heat flow difference signals (DSC signals) are obtained over time while heating or cooling the measurement sample S through the heater 12 or a cooling part (not shown) (step S14).

The processing of step S14 is the same as processing that is performed by a differential scanning calorimeter (DSC) of the related art, the measurement sample S itself is heated or cooled, and corresponding differential scanning calories (DSC) are measured.

In the present disclosure, DSC signals are obtained with respect to any one variable of time or temperature. In common differential scanning calorimeters, the heating or cooling rate is constant and time and temperature are related to each other.

The CCD camera 32 obtains image data of the image of the measurement sample S over time and outputs the image data to the CPU 51 (step S16).

When image data is obtained in step S16, the same variable as the variable (time in this embodiment) used for obtaining heat flow difference signals (DSC signals) in step S14 may be used, but other variables may be used.

Next, image data corresponding to the location information of the measurement sample S set in step S12 is obtained from the image data over time in step S16 by the CPU 51 (step S18).

The image data is stored in the storage unit 52.

When the measurement sample S is a region having an area, the average value of the luminance or intensity of the pixels of the image data in the region is employed.

The image data of the measurement sample S obtained in step S18 and the heat flow difference signals (DSC signal) of the measurement sample S obtained in step S14 are superimposed on each other on the display 53 (step S20).

Next, the user determines whether it is required to end measurement, and ends measurement when it is required (YES), and returns to step S14 when it is not required (NO) (step S22).

When determining whether it is required to end measurement in step S22, for example, it may be possible to determine that it is required to end measurement by setting in advance the maximum temperature or the minimum temperature for heating or cooling the measurement sample as end temperature, but the present disclosure is not specifically limited.

Visible light is emitted from a light source in the embodiment described above, but electromagnetic waves such as X-rays, infrared light, and ultraviolet light other than visible light may be emitted and the reflective light may be detected through a detector such as an X-ray detector other than a CCD camera.

It may be possible to use color variation when obtaining an image of a measurement sample S. In terms of the color, information that quantifies colors may be used in addition to luminance of specific wavelengths. As the numeric information, there are Lab (L*a*b*) values of CIE (International Commission on Illumination) 1976 color space, RGB values expressing colors using combinations of red, green, and blue called ‘three primary colors of light’, CMYK values expressing colors using combinations of cyan, magenta, and yellow, which are called ‘three primary colors’, and black, etc., but the present disclosure is not limited thereto. For example, XYZ values of CIE 1931 color space, L*u*v values of CIE 1976 color space, CIECAM02, etc. may be used.

The present disclosure is not limited to the embodiments described above and covers even various modifications and equivalents included in the spirit and scope of the present disclosure.

For example, the shapes of the sample container, the body, the pressure plate, and the lid are not limited to the examples described above. For example, the sample container is not limited to a cylinder and may be a polygonal cylinder or an elliptical cylinder.

The thermal analyzer of the present disclosure, which measures the physical properties of samples when the temperature of the measurement targets (samples) is controlled through programs, can be applied to a thermal analyzer having the function of differential scanning calorimetry (DSC) that detects a heat flow difference, other than the above-mentioned thermogravimeter-differential thermal analyzer (TG/DTA) defined in “General rules for thermal analysis” in JIS K 0129:2005, and can also be applied to a differential thermal analyzer (TDA) and a thermogravimeter (TG).

What is claimed is:

1. A sample container used with a thermal analyzer for measurement of thermal behavior according to temperature variation from heating or cooling of a measurement sample and observation of the measurement sample, the sample container comprising:
a body in a cylindrical shape having a bottom and a top that is open;
a transparent or translucent pressure plate accommodated in the body to press down on the measurement sample placed on a bottom surface of the body; and
a lid accommodated in the body, placed on top of the pressure plate, and having a hole for observing the measurement sample.

2. The sample container according to claim 1, further comprising a pressing means configured to press the lid toward the pressure plate.

3. The sample container according to claim 1, wherein the lid forms a flange vertically rising upward from an outer circumferential edge of the lid,
the pressing means is an edge of opening of the body and the flange, and
at least portions of the edge of opening of the body and the flange can be folded downward together.

4. The sample container according to claim 2, wherein the lid forms a flange vertically rising upward from an outer circumferential edge of the lid,
the pressing means is an edge of opening of the body and the flange, and
at least portions of the edge of opening of the body and the flange can be folded downward together.

5. The sample container according to claim 3, wherein the sample container has the measurement sample between the bottom surface of the body and the pressure plate, and
the pressing means is made of a bent portions from folding at least portions of the edge of the opening of the body and the flange downward together.

6. The sample container according to claim 4, wherein the sample container has the measurement sample between the bottom surface of the body and the pressure plate, and
the pressing means is made of a bent portions from folding at least portions of the edge of the opening of the body and the flange downward together.

7. The sample container according to claim 1, wherein 0.4≤C2/C1≤0.9 is satisfied where a circle equivalent diameter of the lid is C1 and a circle equivalent diameter of the hole is C2.

8. The sample container according to claim 2, wherein 0.4≤C2/C1≤0.9 is satisfied where a circle equivalent diameter of the lid is C1 and a circle equivalent diameter of the hole is C2.

9. The sample container according to claim 1, wherein thickness of the lid is greater than or equal to thickness of side wall of the body.

10. The sample container according to claim 2, wherein thickness of the lid is greater than or equal to thickness of side wall of the body.

11. A thermal analyzer comprising a sample container according to claim 1, a furnace surrounding the sample container and having an opening for observation, and an imaging means enabling observation of the measurement sample through the opening for observation,
wherein the thermal analyzer measures thermal behavior of the measurement sample according to a temperature variation of the measurement sample in the furnace.

12. A thermal analyzer comprising a sample container according to claim 2, a furnace surrounding the sample container and having an opening for observation, and an imaging means enabling observation of the measurement sample through the opening for observation,
wherein the thermal analyzer measures thermal behavior of the measurement sample according to a temperature variation of the measurement sample in the furnace.

13. The thermal analyzer according to claim 11, wherein the thermal analyzer is a differential thermal analyzer, a differential scanning calorimeter, or a thermogravimetric apparatus.

14. The thermal analyzer according to claim 12, wherein the thermal analyzer is a differential thermal analyzer, a differential scanning calorimeter, or a thermogravimetric apparatus.

15. The thermal analyzer according to claim 11, further comprising an image processing means configured to generate predetermined color information from image data of the measurement sample obtained through the imaging means,
wherein the color information and the thermal behavior are displayed superimposed with respect to temperature.

16. The thermal analyzer according to claim 12, further comprising an image processing means configured to generate predetermined color information from image data of the measurement sample obtained through the imaging means,
wherein the color information and the thermal behavior are displayed superimposed with respect to temperature.
